(19) United States
(12) Patent Application Publication
(10) Pub. No.: US 2008/0077869 A1
(43) Pub. Date: Mar. 27, 2008

(54) Conference supporting apparatus, method, and computer program product

(75) Inventors: Kenta Cho, Tokyo (JP); Masayuki Okamoto, Kanagawa (JP); Hideo Umeki, Kanagawa (JP); Naoki Iketani, Kanagawa (JP); Yuzo Okamoto, Kanagawa (JP); Keisuke Nishimura, Kanagawa (JP)

Correspondence Address: NIXON & VANDERHYE, PC, 901 NORTH GLEBE ROAD, 11TH FLOOR, ARLINGTON, VA, 22203, US

(73) Assignee: Kabushiki Kaisha Toshiba, Tokyo (JP)

(21) Appl. No.: 11/878,874

(22) Filed: Jul. 27, 2007

(30) Foreign Application Priority Data
Sep. 22, 2006 (JP) 2006-257485

(51) Int. Cl. G06F 3/00

(52) U.S. Cl. 715/753

(57) ABSTRACT

A conference supporting apparatus acquires structured data recorded with conference content in time series, and acquires information input during a conference. Keywords are extracted from the structured data and the input information. An abstract level of each of the keywords is specified in accordance with predetermined rules. Importance level of each of the keywords is calculated based on the input information. Finally, a heading for each of the abstract levels is specified from the keywords based on the importance levels.

### CROSS-REFERENCE TO RELATED APPLICATIONS

This application is based upon and claims the benefit of priority from the prior Japanese Patent Application No. 2006-257485, filed on Sep. 22, 2006; the entire contents of which are incorporated herein by reference.

### BACKGROUND OF THE INVENTION

1. Field of the Invention

The present invention relates to a conference supporting apparatus that refers to conference data recorded in time series, a conference supporting method, and a conference supporting program.

2. Description of the Related Art

Conventionally, there has been known a technique of recording information of a conference in time series, and at a later stage adding content of speech to the recorded information. This technique improves the convenience of use of the recorded information.

For example, there has been known an apparatus that visualizes a presentation of conference materials, speech content, and marking content, after structuring the presentation and contents (for example, see JP-A H11-272679 (KOKAI)). Furthermore, there has been known an apparatus that generates a segment of a conference video concerning topics of the same speaker, from important words and speech of each speaker extracted from conference minutes (for example, see JP-A 2004-23661 (KOKAI)).

Generally, various types of data are used or produced in a conference apart from the conference material. Such data include audio data obtained by recording a speech of the speaker or the participants, character data that is written manually by the speaker or the participant. It has been difficult conventionally to manage such a variety of data and search data of a desired part.

### SUMMARY OF THE INVENTION

According to an aspect of the present invention, a conference supporting apparatus includes a first acquiring unit that acquires structured data recorded with conference content in time series; a second acquiring unit that acquires input information input during a conference from an input device; a first storing unit that stores therein the structured data and the input information; an extracting unit that extracts keywords from the structured data and the input information stored in the first storing unit; a first specifying unit that specifies an abstract level of each of the keywords based on predetermined rules; a calculating unit that calculates importance level of each of the keywords based on the input information stored in the first storing unit; a second specifying unit that specifies a heading for each of the abstract levels from the keywords based on the importance levels; a determining unit that determines a hierarchical structure representing a relationship between the headings based on the abstract level of each of the headings; and a receiving unit that receives information on a desired part of the input information and the structured data stored in the first storing unit based on the hierarchically structured headings.

According to another aspect of the present invention, a conference supporting method includes acquiring structured data having conference content recorded in time series; acquiring input information input during a conference; extracting keywords from the structured data and the input information stored in a storing unit that stores therein the structured data and the input information; specifying abstract level of each of the keywords in accordance with predetermined rules; calculating importance level of each of the keywords based on the input information; specifying a heading for each of the abstract levels from the keywords based on the importance levels; determining a hierarchical structure representing a relationship between the headings based on the abstract level of each of the headings; and receiving information on a desired part of the structured data and the input information, with respect to the structured data and the input information stored in the first storing unit, based on hierarchically structured headings.

According to another aspect of the present invention, a computer program product that has a computer-readable recording medium containing a plurality of instructions for referring conference data recorded in time series, and that can be executed by a computer, the plurality of instructions cause the computer to execute first acquiring including acquiring structured data having conference content recorded in time series; acquiring input information input during a conference; extracting keywords from the structured data and the input information stored in a storing unit that stores therein the structured data and the input information; specifying abstract level of each of the keywords in accordance with predetermined rules; calculating importance level of each of the keywords based on the input information; specifying a heading for each of the abstract levels from the keywords based on the importance levels; determining a hierarchical structure representing a relationship between the headings based on the abstract level of each of the headings; and receiving information on a desired part of the structured data and the input information, with respect to the structured data and the input information stored in the first storing unit, based on hierarchically structured headings.

### BRIEF DESCRIPTION OF THE DRAWINGS

FIG. 1 depicts a configuration of a conference supporting system according to an embodiment of the present invention;

FIG. 2 is schematic for explaining an example of arrangement of each unit of the conference supporting system shown in FIG. 1;

FIG. 3 is a schematic diagram for explaining the rules used for conference minutes;

FIG. 4 is a schematic diagram for explaining the abstract level rules used for a slide;

FIG. 5 depicts a data structure of a keyword DB shown in FIG. 1;

FIG. 6 depicts a data structure of an importance-level reduction-rate storing unit shown in FIG. 1;

FIG. 7 is a schematic diagram for explaining a process of identifying a heading from a keyword to which an abstract level “high” is provided as an attribute;

FIG. 8 is a schematic diagram for explaining a process of identifying a heading from a keyword to which an abstract level “intermediate” is provided as an attribute;

FIG. 9 is a schematic diagram for explaining a process of identifying a heading from a keyword to which no abstract level is assigned;

FIG. 10 is an example of a display of a heading;

FIG. 11 is a flowchart of a conference supporting process carried out by a meeting server shown in FIG. 1;

FIG. 12 is a detailed flowchart of an attribute addition process (step S102) shown in FIG. 11;

FIG. 13 is another detailed flowchart of an attribute allocation process (step S102) shown in FIG. 11;

FIG. 14 is still another detailed flowchart of an attribute allocation process (step S102) shown in FIG. 11;

FIG. 15 is a detailed flowchart of an importance calculation process (step S108) shown in FIG. 11; and

FIG. 16 depicts a hardware configuration of the meeting server shown in FIG. 1.

### DETAILED DESCRIPTION OF THE INVENTION

Exemplary embodiments of the present invention are explained in detail below with reference to the accompanying drawings.

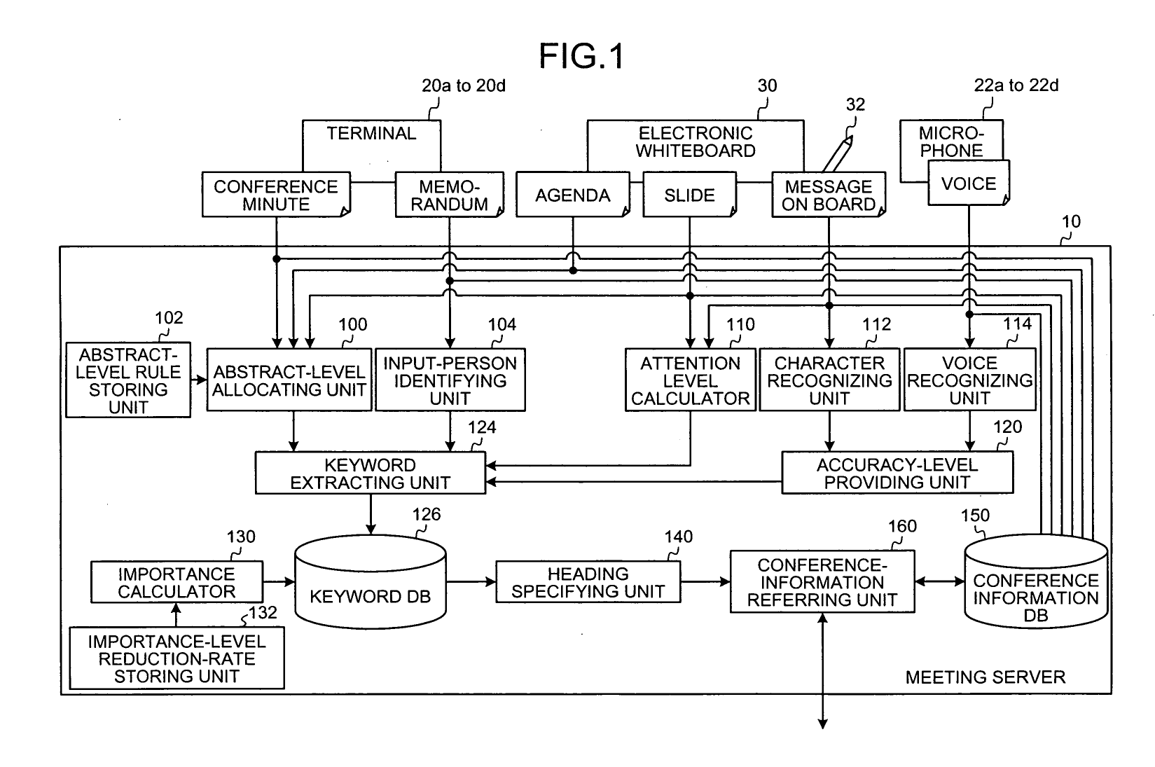

As shown in FIG. 1, a conference supporting system 1 includes a meeting server 10, terminals 20a to 20d, microphones 22a to 22d, an electronic whiteboard 30, and an input pen 32.

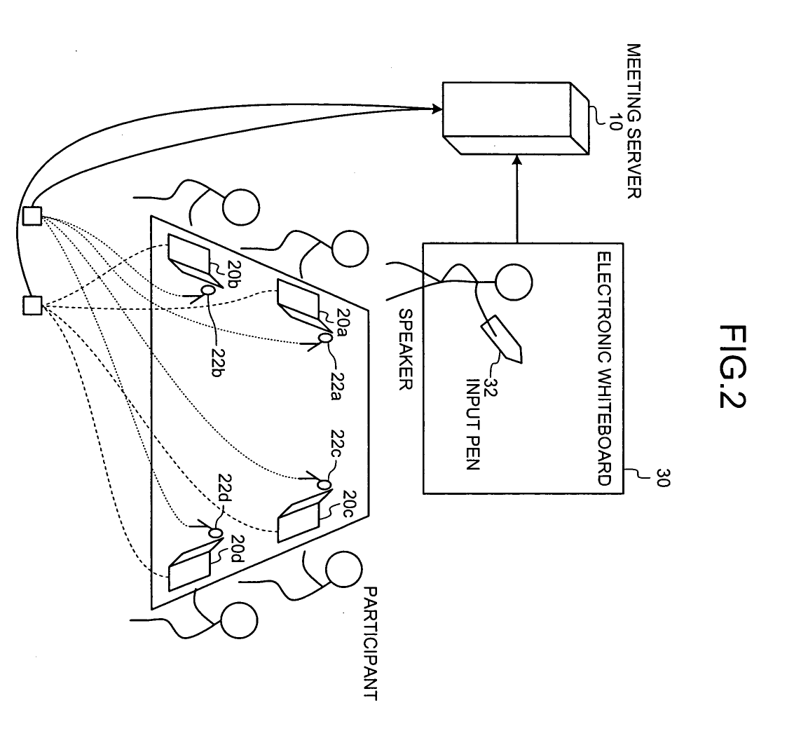

Various units of the conference supporting system 1 can be installed in the manner shown in FIG. 2. A speaker progresses a conference by displaying a desired slide on the electronic whiteboard 30, and pointing desired portions on the slide and writing desired characters on the whiteboard 30 with the input pen 32 according to need. Each participants of the conference is allocated with one of the terminals 20a to 20d and one of the microphones 22a to 22d. The participants can write memorandums (take notes) by using their terminals 20a to 20d. Words uttered by the participants are collected by the microphones 22a to 22d.

Information input to the electronic whiteboard 30 and the terminals 20a to 20d, and information input by using the input pen 32 are transmitted to the meeting server 10. For example, written memorandums and conference minutes are transmitted to the meeting server 10 from the terminals 20a to 20d, comments on the conference content are transmitted to the meeting server 10 from the microphones 22a to 22d, and slides and agendas are transmitted to the meeting server 10 from the electronic whiteboard 30.

The meeting server 10 includes an abstract-level allocating unit 100, an abstract-level rule storing unit 102, an input-person identifying unit 104, an attention level calculator 110, a character recognizing unit 112, a voice recognizing unit 114, an accuracy-level providing unit 120, a keyword extracting unit 124, a keyword database (DB) 126, an importance calculator 130, an importance-level reduction-rate storing unit 132, a heading specifying unit 140, a conference information DB 150, and a conference-information referring unit 160.

The abstract-level allocating unit 100 acquires structured data concerning conference content from the external devices, such as the electronic whiteboard 30, the input pen 32, the terminals 20a to 20d, and the microphones 22a to 22d. The structured data is document data described in a predetermined format. Specifically, the abstract-level allocating unit 100 acquires, as the structured data, the agenda and slides displayed on the electronic whiteboard 30 from the electronic whiteboard 30. There is no specific limitation on the timing of acquiring the slides. The slides can be acquired, for example, during the conference, after the conference ends, or even before the conference begins.

The abstract-level allocating unit 100 acquires, as the structured data, the conference minutes prepared on the terminals 20a to 20d by the participants. There is no specific limitation on the timing of acquiring the conference minutes. The conference minutes can be obtained, for example, each time when the minutes are prepared during the conference, or can be collectively obtained after the conference ends.

The abstract-level allocating unit 100 extracts a chunk from the structured data. A chunk is a group of sentences. For example, the abstract-level allocating unit 100 extracts a chapter title as one chunk. Alternatively, the abstract-level allocating unit 100 can extract content in the sentence as one chunk.

The abstract-level allocating unit 100 allocates an abstract level to each extracted chunk. The abstract level means a level of abstractness of the conference content. For example, the heading of the conference content that is at the highest level is generally very abstract, so that such a heading has the highest abstract level. On the other hand, the conference content that is at the lowest level is generally very specific, so that such conference content has the lowest abstract level. Among conference contents, content having higher abstract levels include a larger variety of content, and are the ones that are discussed for a longer time. On the other hand, conference content having lower abstract levels are the ones that are more specific. In other words, conference content having lower abstract levels are discussed only for a shorter time. For example, keywords such as “progress report” and “specification investigation” have higher abstract levels, while a keyword such as “ID management failure” concerning specific discussion content has a low abstract level.

The abstract-level allocating unit 100 allocates an abstract level to each chunk based on abstract level rules stored in the abstract-level rule storing unit 102. The abstract-level allocating unit 100 adds the abstract level to each chunk as an attribute.

When the structured data relates to slides, a time when each slide is displayed during a conference is added to each chunk. The same applies to the agenda. When the structured data relates to a conference agenda prepared during a conference, a time point at which a chunk is prepared is added to each chunk.

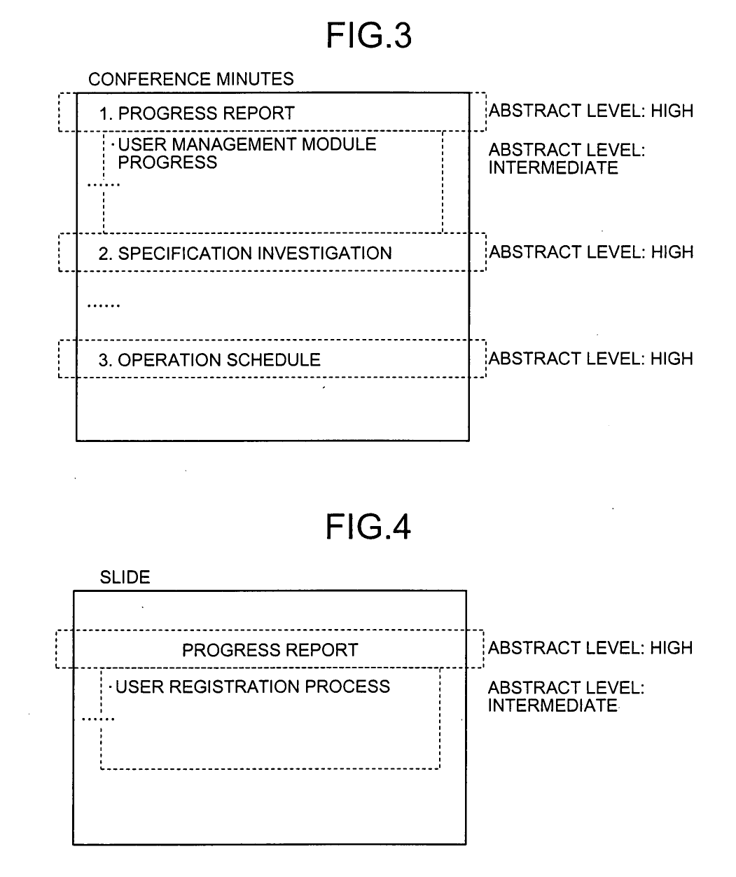

The abstract-level rule storing unit 102 stores therein the abstract level rules for each structured data. FIG. 3 is a schematic diagram for explaining the rule of the conference minutes. As shown in FIG. 3, in the conference minutes, higher-level headings are described following each number of “1.” and “2.”. Content that fall under the higher-level headings is placed at an indented position from the position of the higher-level headings.

As abstract level rules for the conference minutes, it is defined that the abstract level of the chunks corresponding to higher-level headings are set to “high”. The abstract levels of the chunks corresponding to the content following the higher-level headings are set to “intermediate”. In this manner, in the abstract level rule for the conference minutes, the abstract level is allocated based on the position of a chunk.

As shown in FIG. 4, in case of slides, a title of each slide is generally described in the topmost portion of each slide. Following this title, content corresponding to characters smaller than the characters of the title is described.

As abstract level rules for the slides, it is defined that the abstract level of the chunk corresponding to topmost portion of each slide is set to “high”. It is also defined that the abstract level of the chunk corresponding to the content described following the title is set to “intermediate”. In this manner, in the abstract level rule for the slides, the abstract level allocated based on the position of a chunk.

As described above, the abstract level rules describe the definitions to allocate abstract levels to contents based on positions of chunks in the structured data. The abstract-level rule storing unit 102 stores therein the abstract level rules.

Abstract level rules are not necessary to be the ones that are explained above. In other words, abstract level rules can be any rules that specify an abstract level of each chunk of a document. Abstract level rules can be created based on the character size and the character color in the chunk instead of position of the chunk. If abstract level rules are created based on the character size and the character color in the chunk, information concerning the conference content does not need to be the structured data.

While three abstract levels “high”, “intermediate”, and “low” are mentioned above, there can be only two abstract levels, or there can be more than three abstract levels.

Referring back to FIG. 1, the input-person identifying unit 104 acquires a memorandum input by the participants at the terminals 20a to 20d, and generates a chunk from those memorandum. The input-person identifying unit 104 allocates a unique identifier (user ID) corresponding to each participant (input person) to the chunk of the memorandum as an attribute. The input-person identifying unit 104 adds to the chunk a time when the memorandum is input.

The participants who use the terminals 20a to 20d are registered in the input-person identifying unit 104 in advance. Specifically, the input-person identifying unit 104 stores therein unique device identifiers (device ID) for identifying the terminals 20a to 20d and the user IDs for identifying the participants by relating these IDs to each other. The input-person identifying unit 104 identifies a transmitter from whom the memorandum is obtained, and allocates the correspondent participant as the input person. The input-person identifying unit 104 adds to each chunk the identified input person as an attribute.

If a slide is displayed, the attention level calculator 110 allocates an attribute indicating a high attention level to all the chunks in that slide. Moreover, if a speaker points with the input pen 32 a chunk in a displayed slide, the attention level calculator 110 allocates an attribute indicating a high attention level to that chunk. When a speaker manually inputs a chunk (characters) with the input pen 32 in a slide, the attention level calculator 110 allocates an attribute indicating a high attention level to that chunk. Furthermore, the attention level calculator 110 adds a time when the slide is displayed as an attribute.

Alternatively, a “high attention-level” attribute can be allocated only to the indicated chunk, or a “high attention-level” attribute can be provided to all chunks contained in a slide specified by the speaker.

The character recognizing unit 112 acquires the characters manually input with the input pen 32 to the electronic whiteboard 30, and recognizes the manually input characters. The character recognizing unit 112 generates a chunk including text data obtained by recognizing the characters. The character recognizing unit 112 allocates to each chunk a user ID of the participant who inputs the characters. The character recognizing unit 112 also adds a time when the hand-written characters corresponding to chunks are input. The character recognizing unit 112 stores therein in advance the user IDs of the participants or the speaker, and adds those user IDs as the attribute.

The voice recognizing unit 114 also acquires voice input from the microphones 22a to 22d, and recognizes the voice. The voice recognizing unit 114 further generates a chunk including text data obtained by recognizing the voice. The voice recognizing unit 114 allocates to each chunk a user ID of the speaker. The voice recognizing unit 114 stores therein a table in which the device IDs of the microphones 22a to 22d are related to the user IDs of the participants. The voice recognizing unit 114 identifies a user ID corresponding to the device of the voice transmitter based on this table. The voice recognizing unit 114 adds as an attribute a time at which voice corresponding to each chunk is input.

The accuracy-level providing unit 120 acquires a chunk from the character recognizing unit 112 and the voice recognizing unit 114, and allocates an attribute indicating an accuracy level low to the chunk.

Hand-written characters to be recognized by the character recognizing unit 112 are drawn in a free layout in the electronic whiteboard. Therefore, a probability that an accurate recognition result is obtained by the recognition engine is generally low. Therefore, in the present embodiment, a low accuracy level low attribute is allocated to the chunks obtained by the character recognizing unit 112. The same is the case with the chunks corresponding to a result of voice recognition.

Whether the accuracy level is low or not, however, depends on the accuracy level, i.e., efficiency, of the recognition engine. Namely, if a recognition engine that can perform highly accurate voice recognition is used, then this process is not necessary.

The keyword extracting unit 124 analyzes each chunk acquired from the abstract-level allocating unit 100, the input-person identifying unit 104, the attention level calculator 110, and the accuracy-level providing unit 120, into a keyword, based on a mode analysis. When a text is structured and when there is a part in which itemized short phrases are arranged like a slide and conference minutes, these phrases can be directly used as keywords. When a title is newly added to the text, the title can be directly used as a keyword.

The attribute and time allocated to the original chunk are also allocated to the keyword obtained from each chunk. A type of data of the chunk is also recorded. As types of data, there are conference minutes, a memorandum, an agenda, a slide, hand-written characters, and voice. All keywords are stored in the keyword DB 126 by relating the keywords to the time, the attribute, and the type.

It is assumed here that the keyword extracting unit 124 identifies a type of each chunk, and allocates a corresponding keyword to each chunk. Alternatively, any one of the abstract-level allocating unit 100, the input-person identifying unit 104, the attention level calculator 110, the character recognizing unit 112, and the voice recognizing unit 114 can provide a type to obtained chunk. In this case, the keyword extracting unit 124 can provide the type provided to the chunk, to the corresponding keyword.

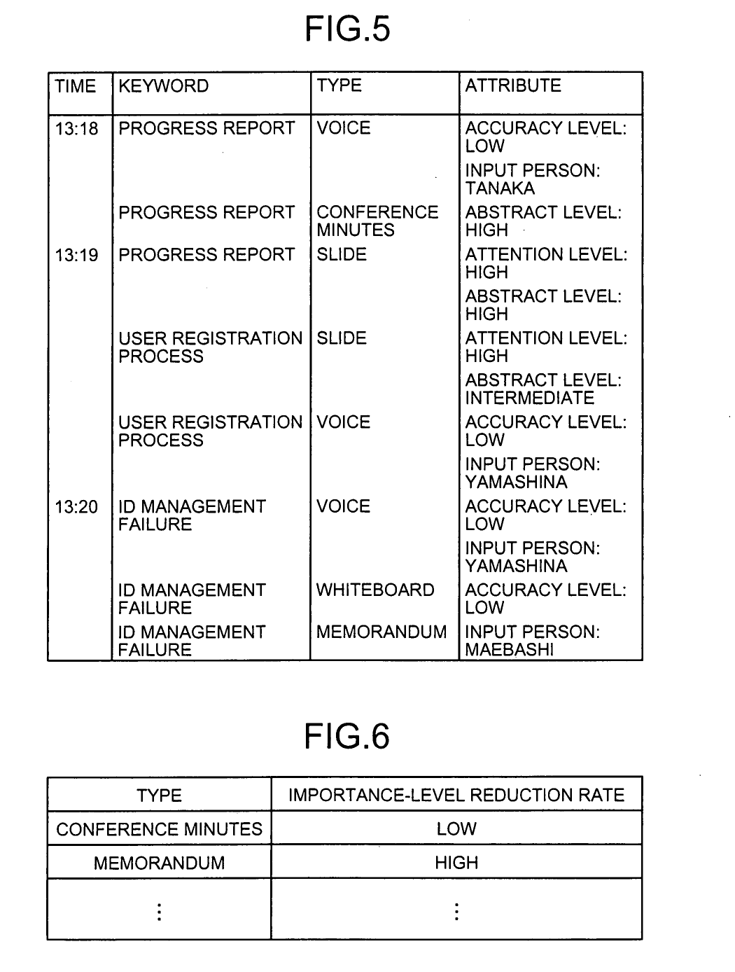

As shown in FIG. 5, the keyword DB 126 stores therein keywords corresponding to times when the keywords are generated. The keywords are recorded in time series. Further, the keywords are related to their types and attributes.

A key word “progress report” at time 13:18 is obtained by relating a phrase “will start the conference with a progress report” stated by Tanaka as a member of the conference at the start of the conference at 13:18. A user ID “Tanaka” obtained by specifying the terminals 20a to 20d of the transmitters is provided as an attribute.

The keyword “progress report” corresponding to the type of conference minutes at this time is obtained corresponding to the input of a large heading of “progress report” in the conference minutes prepared in real time at 13:18 following the progress of the conference at any one of the terminals 20a to 20d. Because the “progress report” is input to a position of a higher-level heading, an attribute showing a high abstract level is provided.

Returning to the explanation of FIG. 1, the importance calculator 130 specifies importance of a keyword at each time of the conference based on the accuracy level of each keyword and based on whether the input person is an important person.

For example, when the accuracy level is “low”, importance is decreased by one. When the attention level is “high”, the importance is increased by one. When the input person is an important person determined in advance, importance is increased by one. Importance at each time is calculated, following the rule determined in advance. Each parameter such as the attention level can be weighted, and importance to be increased and decreased can be differentiated.

The importance-level reduction-rate storing unit 132 stores therein plural importance-level reduction rates by types of keyword. The importance-level reduction rate expresses at what rate importance is reduced following lapse of time. The importance-level reduction rate is determined by types of keywords. For example, voice of which data does not remain after the voice is generated is allocated with a high importance-level reduction rate. Namely, it is reduced fast. On the other hand, slide data that is continued to be displayed for some time is allocated with a low importance-level reduction rate. Namely, it is reduced slowly.

As shown in FIG. 6, the importance-level reduction-rate storing unit 132 stores therein types of keywords and importance-level reduction rates, by relating them to each other. With this arrangement, an importance-level reduction rate corresponding to a type can be used. The importance calculator 130 decreases the importance according to lapse of time, using the importance-level reduction rate related to the type of a keyword to be processed by the importance-level reduction-rate storing unit 132.

The heading specifying unit 140 specifies a heading at each time of the conference, based on a time lapse of importance calculated by the importance calculator 130. Specifically, the heading specifying unit 140 classifies the keywords based on their abstract levels, and then specifies heading for each abstract level.

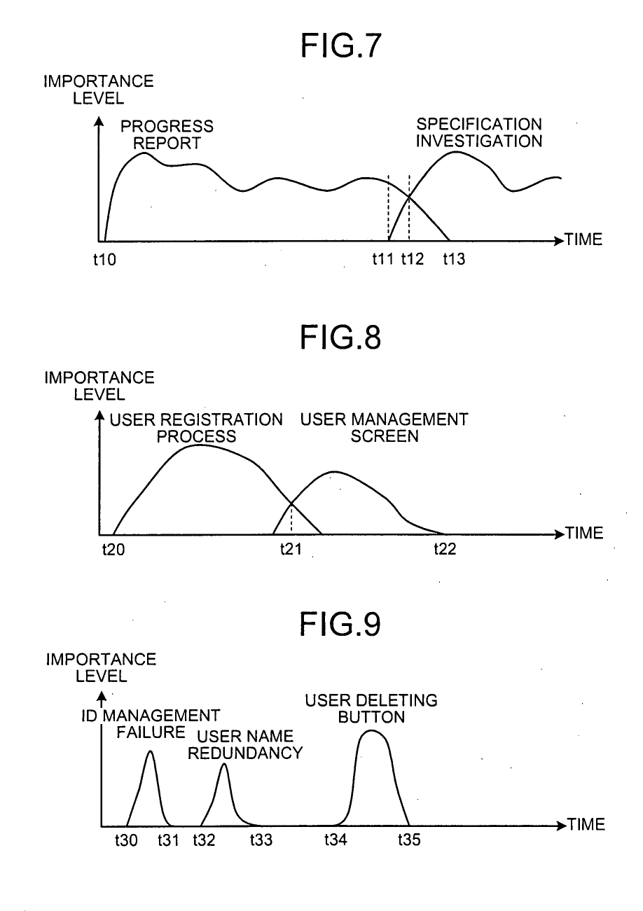

FIG. 7 is a graph showing a temporal change of importance of a keyword to which the abstract level “high” is assigned as the attribute. Assume that a keyword “progress report” appears during time t10 and t13, while a keyword “specification investigation” appears at time t11. In this example, the keyword “progress report” is specified as a heading during the period from time t10 and t11.

While the two keywords “progress report” and “specification investigation” appear during time t11 and t12, the “progress report” has larger importance. Therefore, the “progress report” is specified as a heading during the period from time t11 and t12. At and after time t12, the keyword “specification investigation” has larger importance so that the keyword “specification investigation” is specified as a heading after time t13. As explained above, a keyword having high importance is specified as a heading.

FIG. 8 is a graph showing a temporal change of importance of a keyword to which the abstract level “intermediate” is assigned as the attribute. In the example shown in FIG. 8, a keyword “user registration process” is specified as a heading during a period from time t20 to t21. During a period from time t21 to t22, however, a keyword “user management screen” is specified as a heading.

FIG. 9 is a graph showing a temporal change of importance of a keyword to which any abstract level is not assigned. In the example shown in FIG. 9, a keyword “ID management failure” is specified as a heading during a period from time t30 to t31. During a period from t32 to t33, a keyword “user name redundancy” is specified as a heading. During a period from t34 to t35, a keyword “user deleting button” is specified as a heading. As explained above, the heading specifying unit 140 can specify a heading for each abstract level, that is, headings of different levels.

When many short headings appear, it becomes inconvenient to use these headings. In a time zone during which a part having the largest importance of the same keyword continues, when another keyword has the largest importance during a very short period, this another heading is removed as noise, and the surrounding keyword having the largest importance is used as the heading. Namely, a keyword having the largest importance during only a short time shorter than a predetermined period is not used as a keyword, and the surrounding keyword is used as a heading.

Instead of the value of importance, the increase rate of importance can be taken into consideration. A part where the increase rate is large is where reference to a certain keyword increases rapidly. Therefore, a keyword corresponding to the large increase rate is used as a heading.

The conference information DB 150 acquires all information concerning the conference obtained from the external devices, and stores therein the information. Specifically, the conference information DB 150 acquires conference minutes from the terminals 20a to 20d, and acquires memorandum from the input pen 32. The conference information DB 150 acquires the agenda, the slide, and the handwritten characters, and acquires voice from the microphones 22a to 22d.

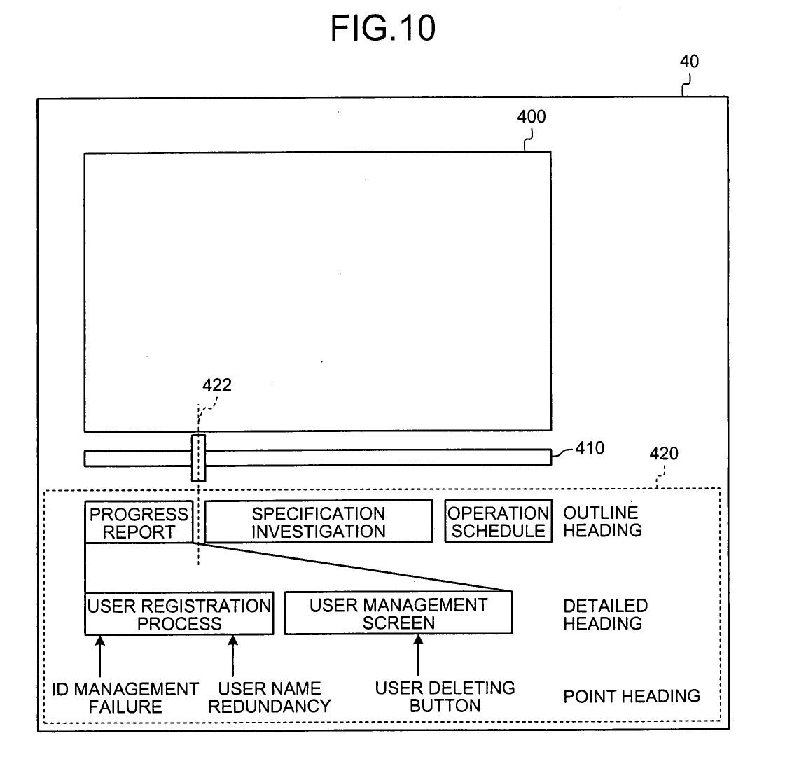

The conference-information referring unit 160 displays the heading specified by the heading specifying unit 140. FIG. 10 is an example of a display of a heading. A display screen 40 includes a whiteboard reference area 400 for reproducing information displayed on the electronic whiteboard 30, and a slider 410 for setting a time of reproducing an optional part of the conference. A header display area 42 is located below the slider 410.

Each heading specified by the heading specifying unit 140 is displayed in the heading display area 420. The heading is classified into three of an outline heading, a detailed heading, and a point heading. The outline heading is specified from a keyword of an abstract level “high”. The detailed heading is specified from a keyword of an abstract level “intermediate”. The point keyword is specified from a keyword not provided with an abstract level. As explained above, each heading is structured and displayed in three hierarchies according to the abstract level.

When the outline heading is clicked, detailed headings contained in the time zone corresponding to this outline heading are developed and displayed. In this case, a time when the point heading occurs is also displayed. When the detailed heading is clicked, point headings are displayed in development.

The outline heading in the heading display area 420 is displayed at a position where the time of each outline heading and the time of the slider 410 coincide. Therefore, to reproduce the content from the start point of “specification investigation”, the slider 410 is set to a start position 422 of “specification investigation”. It can be also arranged such that when the area of “specification investigation” is double clicked, the slider 410 automatically moves to the start position 422 of “specification investigation”.

When a user specifies a start position on the display screen 40, the conference-information referring unit 160 extracts and outputs the corresponding conference information from the conference information DB 150.

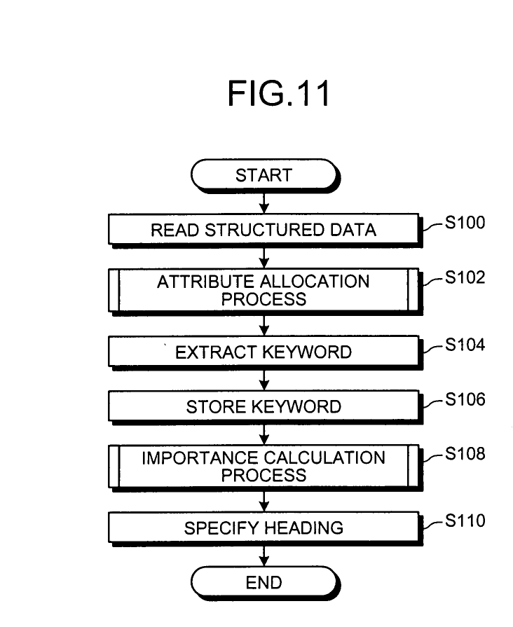

As shown in FIG. 11, in the conference support process carried out by the meeting server 10, the abstract-level allocating unit 100 first reads structured data (step S100). Next, each of the abstract-level allocating unit 100, the abstract-level rule storing unit 102, and the input-person identifying unit 104 perform an attribute allocation process to the chunk obtained from the external device (step S102). The attention level calculator 110 extracts a keyword from each chunk (step S104). The attention level calculator 110 stores the extracted keyword into the keyword DB 126 by relating the keyword to the corresponding time and attribute (step S106).

The importance calculator 130 performs importance calculation process on each keyword stored in the keyword DB 126 (step S108). The heading specifying unit 140 specifies a heading for each abstract level based on importance calculated by the importance calculator 130 (step S110). The conference supporting process is completed in the above.

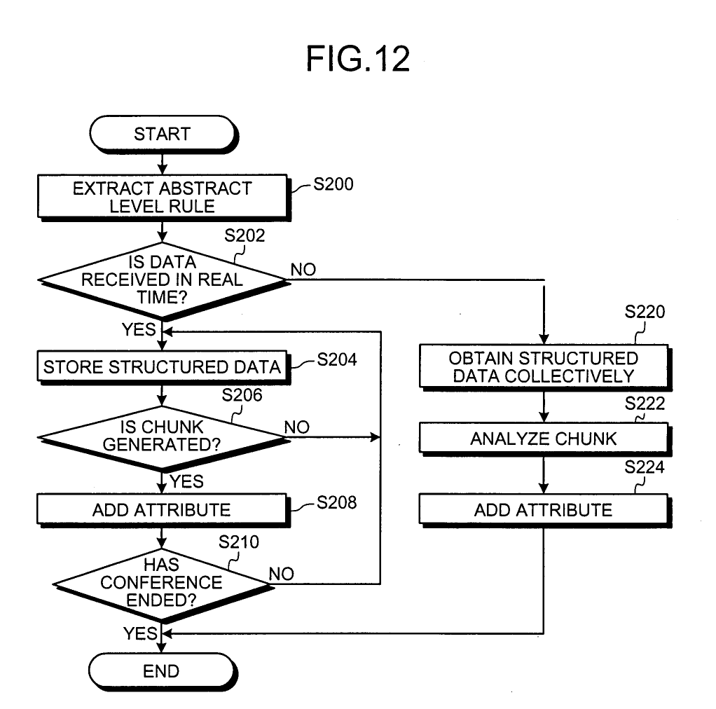

FIG. 12 depicts a detailed flowchart of an attribute allocation process (i.e., step S102 shown in FIG. 11) at the time of providing an attribute to a chunk of structured data. The abstract-level allocating unit 100 extracts an abstract level rule corresponding to the format of structured data from the abstract-level rule storing unit 102 (step S200).

The abstract-level allocating unit 100 decides whether the structured data is received in real time (step S202). Specifically, the abstract-level allocating unit 100 decides whether the structured data is input or presented to match the progress of the conference. At the time of inputting information prepared in advance such as an agenda, the information is decided to be not input in real time.

When data is input in real time (YES at step S202), the structured data is stored (step S204). When a chunk is generated (YES at step S206), an attribute of an abstract-level attribute is added to the chunk (step S208). As a method of determining a chunk generation, a continuous input carried out during a constant time is determined as a chunk, and when the continuous input is completed, it is determined that the chunk is generated at this time. The above process is carried out until the conference ends (YES at step S210).

On the other hand, when structured data is input in non-real time (NO at step S202), the structured data are collectively obtained (step S220). The chunk is analyzed (step S222), and the attribute is added (step S224). In this case, the attribute showing that the chunk is a non-real time input is also added to the chunk. The process of giving the attribute to the chunk of the structured data is completed in the above.

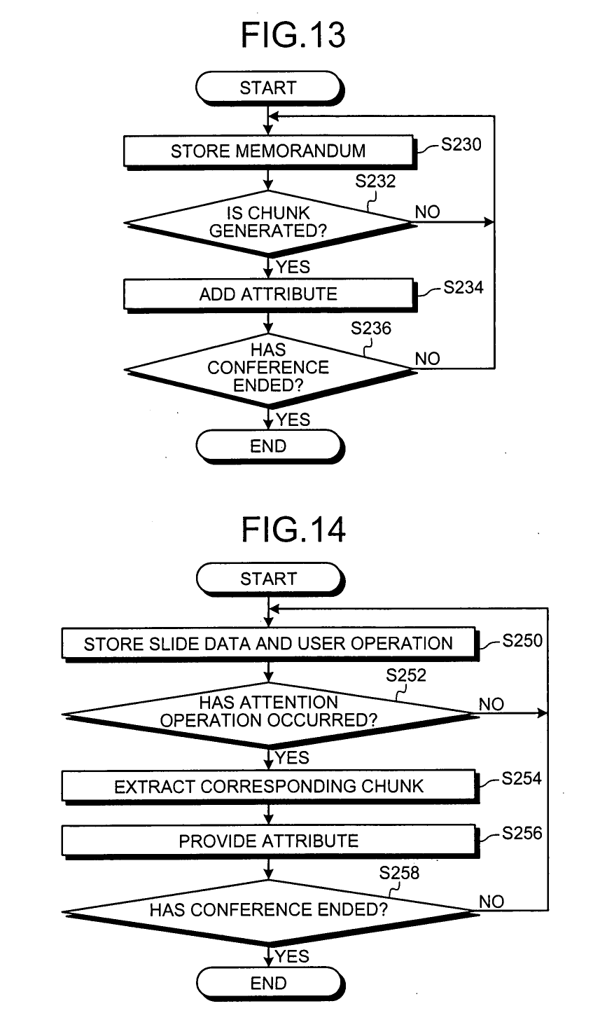

FIG. 13 depicts a detailed flowchart of an attribute allocation process at the time of giving an attribute to the chunk of the memorandum (i.e., step S102 shown in FIG. 11). The abstract-level allocating unit 100 stores content input each time when the memorandum is input from the terminals 20a to 20d (step S230). When the chunk is generated (YES at step S232), the abstract-level allocating unit 100 adds an attribute to the generated chunk (step S234). When no chunk is generated (NO at step S232), the process returns to step S230. The above process is carried out until the conference ends (YES at step S236).

The character recognizing unit 112 processes hand-written characters and the voice recognizing unit 114 processes voice, in a similar manner. Namely, each time when hand-written characters are input, the character recognizing unit 112 stores the input content. When a chunk is generated, the character recognizing unit 112 provides an attribute to the chunk. In the case of hand-written characters, the character recognizing unit 112 determines a continuous drawing as a chunk. Each time when voice is input, the voice recognizing unit 114 stores the input content. When a chunk is generated, the voice recognizing unit 114 provides an attribute to the chunk. The voice recognizing unit 114 determines a speech unit of voice as a chunk.

FIG. 14 depicts a detailed flowchart of an attribute allocation process (i.e., step S102 shown in FIG. 11) at the time of providing an attribute of the attention level to the chunk obtained from slides. The attention level calculator 110 stores slide data, and also stores user operation details (step S250). The user operation is an operation performed by the speaker with respect to the slides. Specifically, the user operation includes the operation of presenting a slide, the operation of tracing a specific part of the slide with the mouse cursor, the operation of indicating a specific part of the slide with the input pen 32, and the operation of writing with the input pen 32.

The attention level calculator 110 determines whether attention operation is carried out (step S252). The attention operation is the operation of drawing attention of the participant. Specifically, the attention operation includes a presentation of a slide, a change of a slide, and an indication of a predetermined area with the input pen 32.

When the attention operation occurs (YES at step S252), the attention level calculator 110 extracts a part corresponding to the attention operation as a chunk (step S254). The attention level calculator 110 provides the attribute of attention-level “high” to the extracted chunk (step S256). The attention level calculator 110 carries out the process until the conference end (YES at step S258).

As other example, the input-person identifying unit 104 can determine presence of a non-attention operation not only attention operation. The non-attention operation means the operation that specific conference information disappears from the attention of the participants, such as the disappearance of a so-far-displayed slide due to a changeover of the slide. When the non-attention operation occurs, the attribute of a “small” attention level is provided. In the importance calculation process, importance is decreased when the “small” attention level is provided.

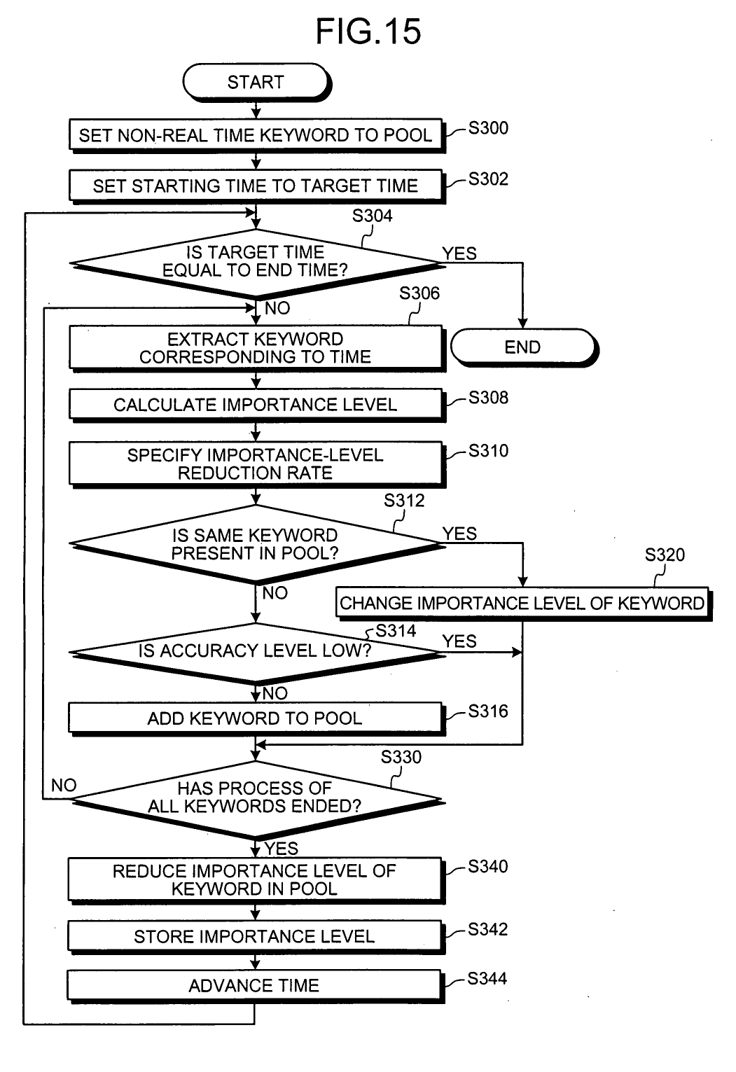

As shown in FIG. 15, in a detailed process in the importance calculation process (i.e., step S108 shown in FIG. 11), a keyword obtained from non-real time structured data is set in a pool (step S300). A non-real time keyword itself does not becomes a heading, but is taken into account at the time of determining importance of the same keyword input in real time.

The pool is used to add and record a keyword and its importance, to forecast a shift of importance of a keyword due to time and to extract a heading, and is developed in the memory.

A conference starting time is set to a target time (step S302). The time is related to each keyword, and is the occurrence time of the corresponding chunk. Importance of the keyword corresponding to each time is sequentially added from the conference starting time to the conference end time (step S304).

A keyword corresponding to the time is extracted from the keyword DB 126 (step S306). A keyword corresponding to the time within a constant period from the time is extracted. The constant period is one minute, for example. Importance is calculated based on each attribute provided to the extracted keyword (step S308). The importance-level reduction rate is specified based on a type of the keyword (step S310).

When a keyword which is the same as this keyword is present in the pool (YES at step S312), the importance of the keyword is added to the importance calculated at step S308 (step S320).

On the other hand, when a keyword which is the same as this keyword is absent in the pool (NO at step S312), importance of the keyword is referred. When the attribute of the accuracy level “low” is not provided to the keyword (NO at step S314), the keyword is added to the pool together with the importance and the importance-level reduction rate (step S316).

When the attribute of the accuracy level “low” is provided to the keyword (YES at step S314), this keyword is not added to the pool. This is because the keyword of the accuracy level “low” is a keyword that is not actually generated due to an erroneous recognition, in many cases. Such a keyword is used to only calculate importance.

The above process is carried out to all keywords at the corresponding times (step S330). After the process of all keywords at the corresponding times has ended (YES at step S330), the importance of all keywords stored in the pool is reduced following the importance-level reduction rate (step S340). The importance after the reduction is stored (step S342). Next, time is advanced (step S344). When the time is not the end time (NO at step S304), process at and after step S306 is carried out.

As explained above, in the conference supporting system 1, hierarchical headings corresponding to the abstract levels can be presented to the user. Therefore, the user can easily specify a desired part from the content of the conference based on this hierarchical structure.

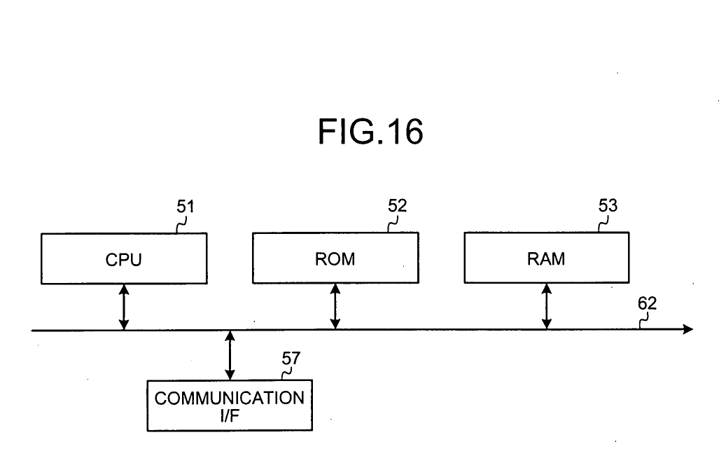

As shown in FIG. 16, the meeting server 10 according to the first embodiment includes, as hardware, a read only memory (ROM) 52 that stores a conference supporting program for the meeting server 10 to execute the conference supporting process; a central processing unit (CPU) 51 that controls each unit of the meeting server 10 following the program within the ROM 52; a random access memory (RAM) 53 for storing various kinds of data necessary to control the meeting server 10; a communication interface (I/F) 57 that carries out communications by being connected to the network; and a bus 62 for connecting between the units.

The conference supporting program can be recorded in a computer-readable recording medium such as a compact disk (CD)-ROM, a floppy disk (FD), and a digital versatile disk (DVD), in an installable-format or executable-format file.

In this case, the meeting server 10 reads the conference supporting program from the recording medium, executes the program, and loads the program onto the main storage device, thereby generating each unit explained in the software configuration on the main storage device.

Alternatively, the conference supporting program can be stored on some other the computer that connected to the meeting server 10 via a network such as the Internet. In this case, the meeting server 10 downloads the conference supporting program from the computer.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A conference supporting apparatus comprising:
a first acquiring unit that acquires structured data recorded with conference content in time series;
a second acquiring unit that acquires input information input during a conference from an input device;
a first storing unit that stores therein the structured data and the input information;
an extracting unit that extracts keywords from the structured data and the input information stored in the first storing unit;
a first specifying unit that specifies an abstract level of each of the keywords based on predetermined rules;
a calculating unit that calculates importance level of each of the keywords based on the input information stored in the first storing unit;
a second specifying unit that specifies a heading for each of the abstract levels from the keywords based on the importance levels;
a determining unit that determines a hierarchical structure representing a relationship between the headings based on the abstract level of each of the headings; and
a receiving unit that receives information on a desired part of the input information and the structured data stored in the first storing unit based on the hierarchically structured headings.

2. The apparatus according to claim 1, wherein
the first acquiring unit acquires the structured data having a structure of the conference recorded in a predetermined format, and
the first specifying unit specifies the abstract level based on a rule concerning the format.

3. The apparatus to claim 1, further comprising a second storing unit that stores rule for each format of the structured data, wherein
the first specifying unit specifies the abstract level based on the rule corresponding to the format of the structured data stored in the second storing unit.

4. The apparatus according to claim 1, further comprising an identifying unit that identifies an input device that input the input information, wherein
the calculating unit calculates the importance level based on the input device identified by the identifying unit.

5. The apparatus according to claim 4, wherein the calculating unit calculates the importance level of a keyword obtained from input information acquired from an input device registered in advance, the importance level being smaller than the importance level of a keyword obtained from input information acquired from an input device other than the registered device.

6. The apparatus according to claim 1, further comprising an identifying unit that identifies a person who input the input information, wherein
the calculating unit calculates the importance level based on the input person identified by the identifying unit.

7. The apparatus according to claim 1, further comprising a reducing unit that sets the importance level calculated by the calculating unit as importance level of the keyword at an appearance time of the keyword, and reduces the importance level based on a reduction rate set in advance according to a lapse time from the appearance time of the keyword, wherein
the second specifying unit specifies the heading based on the importance level after reduction.

8. The apparatus according to claim 7, further comprising:
a third storing unit that stores therein a data type of the input information and the reduction rate by relating the data type and the reduction rate to each other;
a third specifying unit that specifies the data type of the input information; and
a fourth specifying unit that specifies the reduction rate corresponding to the data type stored in the third storing unit, wherein
the reducing unit reduces the importance level in accordance with the reduction rate specified by the fourth specifying unit.

9. A conference supporting method comprising:
acquiring structured data having conference content recorded in time series;
acquiring input information input during a conference;
extracting keywords from the structured data and the input information stored in a storing unit that stores therein the structured data and the input information;
specifying abstract level of each of the keywords in accordance with predetermined rules;
calculating importance level of each of the keywords based on the input information;
specifying a heading for each of the abstract levels from the keywords based on the importance levels;
determining a hierarchical structure representing a relationship between the headings based on the abstract level of each of the headings; and
receiving information on a desired part of the structured data and the input information, with respect to the structured data and the input information stored in the first storing unit, based on hierarchically structured headings.

10. The method according to claim 9, wherein
said step of acquiring the structured data includes acquiring the structured data having a structure of the conference recorded in a predetermined format, and
said step of specifying the abstract level includes specifying the abstract level based on the rule concerning the format.

11. The method according to claim 9, wherein
said step of specifying the abstract level includes specifying the abstract level based on the rule corresponding to the format of the structured data stored in the second storing unit which stores rules for each format of the structured data.

12. The method according to claim 9, further comprising identifying an input device that input the input information, wherein
said step of calculating includes calculating the importance level based on the input device identified at the identifying.

13. The method according to claim 9, further comprising identifying a person who input the input information, wherein
said step of calculating includes calculating the importance level based on the input person identified at the identifying.

14. The method according to claim 9, further comprising setting the importance level calculated at the calculating as importance level of the keyword at an appearance time of the keyword, and reducing the importance level based on a reduction rate set in advance according to a lapse time from the appearance time of the keyword, wherein
said step of specifying the input information includes specifying the heading based on the importance level after reduction.

15. A computer program product that has a computer-readable recording medium containing a plurality of instructions for referring conference data recorded in time series, and that can be executed by a computer, the plurality of instructions making the computer to execute:
acquiring structured data having conference content recorded in time series;
acquiring input information input during a conference;
extracting keywords from the structured data and the input information stored in a storing unit which stores the structured data and the input information;
specifying abstract level of each of the keywords in accordance with predetermined rules;
calculating importance level of each of the keywords based on the input information;
specifying a heading for each of the abstract levels from the keywords based on the importance levels;
determining a hierarchical structure representing a relationship between the headings based on the abstract level of each of the headings; and
receiving information on a desired part of the structured data and the input information, with respect to the structured data and the input information stored in the first storing unit, based on hierarchically structured headings.

16. The computer program product according to claim 15, wherein
said step of acquiring the structured data includes acquiring the structured data having a structure of the conference recorded in a predetermined format, and
said step of specifying the abstract level includes specifying the abstract level based on the rule concerning the format.

17. The computer program product according to claim 15, wherein
said step of specifying the abstract level includes specifying the abstract level based on the rule corresponding to the format of the structured data stored in the second storing unit which stores rules for each format of the structured data.

18. The computer program product according to claim 15, wherein the computer program further causes the computer to execute identifying an input device that input the input information, wherein
said step of calculating includes calculating the importance level based on the input device identified at the identifying.

19. The computer program product according to claim 15, wherein the computer program further causes the computer to execute identifying a person who input the input information, wherein
said step of calculating includes calculating the importance level based on the input person identified at the identifying.

20. The computer program product according to claim 15, wherein the computer program further causes the computer to execute setting the importance level calculated at the calculating as importance level of the keyword at an appearance time of the keyword, and reducing the importance level based on a reduction rate set in advance according to a lapse time from the appearance time of the keyword, wherein
said step of specifying the input information includes specifying the heading based on the importance level after reduction.
